(19) United States
(12) Patent Application Publication
(10) Pub. No.: US 2013/0193227 A1
(43) Pub. Date: Aug. 1, 2013

(54) LIQUID EJECTING HEAD AND LIQUID EJECTING APPARATUS

(71) Applicant: Seiko Epson Corporation, Tokyo (JP)

(72) Inventors: Eiju HIRAI, Okaya (JP); Chikara KOJIMA, Matsumoto (JP)

(73) Assignee: Seiko Epson Corporation, Tokyo (JP)

(21) Appl. No.: 13/753,065

(22) Filed: Jan. 29, 2013

(30) Foreign Application Priority Data
Jan. 31, 2012 (JP) 2012-018739

(51) Int. Cl. B05B 17/06

(52) U.S. Cl. CPC B05B 17/0653
USPC 239/102.2

(57) ABSTRACT

A liquid ejecting head includes a substrate in which pressure generation chambers that communicate with corresponding nozzle openings are formed, and piezoelectric elements having a piezoelectric material layer, a first electrode formed on the side of the substrate that faces the piezoelectric material layer, and second electrodes formed on the opposite side of the piezoelectric material layer as the side on which the first electrode is formed; the piezoelectric material layer is formed upon the entirety of the first electrode. The second electrodes are formed in correspondence with respective pressure generation chambers, and the second electrodes are formed separated from each other by regions on the piezoelectric material layer formed in a continuous manner.

This application claims a priority to Japanese Patent Application No. 2012-018739 filed on Jan. 31, 2012 which is hereby expressly incorporated by reference herein in its entirety.

### BACKGROUND

1. Technical Field

The present invention relates to liquid ejecting heads and liquid ejecting apparatuses.

2. Related Art

A liquid ejecting head that includes a base plate in which pressure generation chambers that communicate with nozzle openings for ejecting a liquid are formed, and piezoelectric elements having a piezoelectric material layer, a lower electrode formed on a lower end of a piezoelectric material layer and upper electrodes formed on an upper end of the piezoelectric material layer is known (see JPA-2010-42683). With such a liquid ejecting head, the lower electrode serves as a common electrode for a plurality of piezoelectric elements that correspond to a plurality of pressure generation chambers, whereas the upper electrodes serve as individual electrodes that correspond to individual pressure generation chambers.

When manufacturing the stated piezoelectric elements, the lower electrode serving as the common electrode is patterned in a predetermined shape upon a layer that serves as the base of the lower electrode (an insulative film configured of zirconium oxide (ZrO₂)), after which the piezoelectric material layer is formed so as to cover a predetermined range of the lower electrode. At this time, part of the piezoelectric material layer is formed so as to make contact with the upper surface, a side surface, and so on of the lower electrode, and another part of the piezoelectric material layer is formed so as to make contact with the stated insulative film. However, a method that forms part of the piezoelectric material layer upon the lower electrode and part of the piezoelectric material layer upon the insulative film is such a manner has several issues.

First, the piezoelectric material layer formed upon the insulative film is more susceptible to problems such as cracking than the piezoelectric material layer formed upon the lower electrode. Here, the piezoelectric material layer that has been formed experiences stress caused by the layer itself attempting to shrink, and in response to this, the insulative film that is in contact with the piezoelectric material layer moves in an attempt to hold the piezoelectric material layer; the stated cracks are produced by these conflicting forces. In addition, when layering the piezoelectric material layer on the stated patterned lower electrode and the stated insulative film, a process of forming a titanium layer has thus far been carried out after the lower electrode patterning and prior to the piezoelectric material layer being formed, with the goal of suppressing the abnormal growth of crystals in the piezoelectric material layer that is on the insulative film. However, this past method has many steps and is complicated, and there has thus been room for improvement in terms of making the manufacture of liquid ejecting heads more efficient.

Furthermore, in liquid ejecting heads, the lower electrode and the upper electrodes are present in an extremely narrow space, and if shorts occur between the electrodes, the liquid ejecting head is useless as a product. There is thus a need to suppress the occurrence of cracking and make the manufacturing process more efficient while also avoiding such shorts.

### SUMMARY

It is an advantage of some aspects of the invention to provide a liquid ejecting head and a liquid ejecting apparatus that suppress various types of problems, such as cracking in a piezoelectric material layer and shorts between electrodes, while also being more efficient to manufacture than in the past.

A liquid ejecting head according to an aspect of the invention includes a substrate in which pressure generation chambers that communicate with corresponding nozzle openings are formed, and piezoelectric elements having a piezoelectric material layer, a first electrode formed on the side of the substrate that faces the piezoelectric material layer, and second electrodes formed on the opposite side of the piezoelectric material layer as the side on which the first electrode is formed; the piezoelectric material layer is formed upon the entirety of the first electrode.

According to this configuration, the base layer of the piezoelectric material layer is always the first electrode, and thus it is possible to avoid problems such as cracking in the piezoelectric material layer that can occur when the piezoelectric material layer is formed upon the insulative film. Furthermore, a process for patterning the first electrode prior to forming the piezoelectric material layer, a special process for suppressing the abnormal growth of crystal on the insulative film, and so on are unnecessary, and thus the liquid ejecting head can be efficiently manufactured.

Another aspect of the invention, it is preferable that the second electrodes be formed in correspondence with respective pressure generation chambers, and the second electrodes be formed separated from each other by regions on the piezoelectric material layer formed in a continuous manner. According to this configuration, the second electrodes are individual electrodes corresponding to respective pressure generation chambers. In addition, the respective individual electrodes are formed so as to be separated from each other by regions on the piezoelectric material layer, and thus the piezoelectric material layer serves as an insulative layer between the first electrode and the second electrodes; as a result, shorts are prevented with certainty from occurring between the first and second electrodes.

According to another aspect of the invention, it is preferable that the liquid ejecting head further include lead electrodes connected to respective second electrodes, and the lead electrodes be formed within a region in which the piezoelectric material layer is formed. According to this configuration, the lead electrodes connected to respective second electrodes are also present within the range in which the piezoelectric material layer is formed, and thus shorts with the first electrode are prevented with certainty.

According to another aspect of the invention, it is preferable that the liquid ejecting head further include opening portions in the piezoelectric material layer formed by removing the second electrodes and the piezoelectric material layer in regions essentially corresponding to spaces between the pressure generation chambers, and opening portions in the second electrodes formed by partially removing the second electrodes on the continuous piezoelectric material layer in order to separate the second electrodes; ends of the opening portions in the piezoelectric material layer be etched when forming the opening portions in the second electrodes. According to this configuration, the region including the ends of the opening portions in the piezoelectric material layer is also etched when forming the opening portions in the second electrode upon the piezoelectric material layer, and thus the respective second electrodes that serve as the individual electrodes are separated with certainty by the opening portions formed in the second electrodes.

Another aspect of the invention, it is preferable that the ends of the opening portions in the piezoelectric material layer be positioned on the outer side of the range of the pressure generation chambers in the lengthwise direction of the pressure generation chambers. The ends of the opening portions of the piezoelectric material layer are regions that are etched when forming the opening portions and are etched when forming the opening portions in the second electrodes, and thus there is a risk that these ends will be made thinner than is necessary, reducing the rigidity thereof as a result. Accordingly, positioning the ends of the opening portions in the piezoelectric material layer on the outer side of the range of the pressure generation chambers in the lengthwise direction of the pressure generation chambers makes it possible to avoid problems such as cracks from occurring in those areas.

According to another aspect of the invention, it is preferable that the liquid ejecting head further include an opening portion in the piezoelectric material layer formed by removing the second electrodes and the piezoelectric material layer in regions essentially corresponding to spaces between the pressure generation chambers, and the opening portions in the piezoelectric material layer be formed within the range of the pressure generation chambers in the lengthwise direction of the pressure generation chambers. According to this configuration, forming the opening portions of the piezoelectric material layer within the range of the pressure generation chambers in the lengthwise direction of the pressure generation chambers increases the rigidity of the piezoelectric elements in the vicinity of the ends of the pressure generation chambers, which makes it possible to avoid the occurrence of problems such as cracks in the piezoelectric material layer near the ends of the pressure generation chambers.

The technical concept of the invention can be realized not only as a liquid ejecting head; for example, a liquid ejecting apparatus including the liquid ejecting head according to any of the stated aspects can also be interpreted as an invention. Furthermore, a manufacturing method including steps for manufacturing the piezoelectric elements, the liquid ejecting head, the liquid ejecting apparatus, and so on according to any of the stated aspects (a piezoelectric element manufacturing method, a liquid ejecting head manufacturing method, a liquid ejecting apparatus manufacturing method, and so on) can also be taken as an invention.

### BRIEF DESCRIPTION OF THE DRAWINGS

The invention will be described with reference to the accompanying drawings, wherein like numbers reference like elements.

FIG. 1 is an exploded perspective view illustrating an overall view of a recording head.

FIG. 2 is a cross-sectional view taken along a surface parallel to the lengthwise direction of the recording head.

FIG. 3 is a plan view illustrating a partial region on a substrate.

FIGS. 4A through 4C are cross-sectional views taken along the respective lines IVA-IVA, IVB-IVB and IVC-IVC, shown in FIG. 3.

FIG. 5 is a plan view illustrating a partial region on a substrate according to a variation.

FIG. 6 is a schematic diagram illustrating an example of an ink jet recording apparatus.

### DESCRIPTION OF EXEMPLARY EMBODIMENTS

Hereinafter, embodiments of the invention will be described with reference to the drawings.

### 1. Overall Configuration of Liquid Ejecting Head

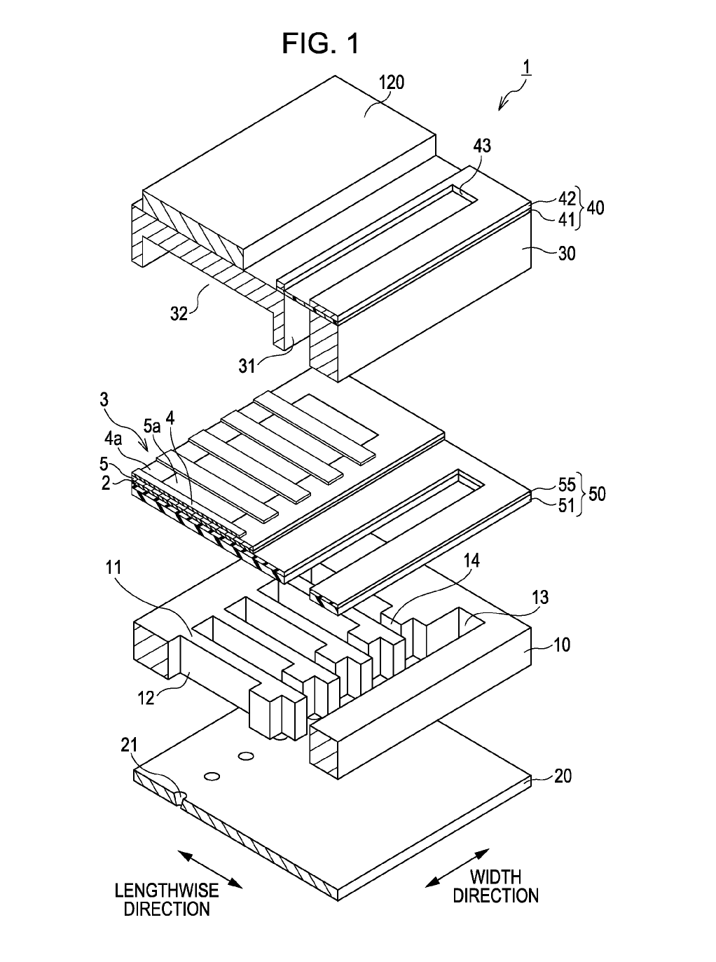

FIG. 1 shows an overview of an ink jet recording head 1 (called a “recording head 1” hereinafter) serving as an example of a liquid ejecting head, using an exploded perspective view.

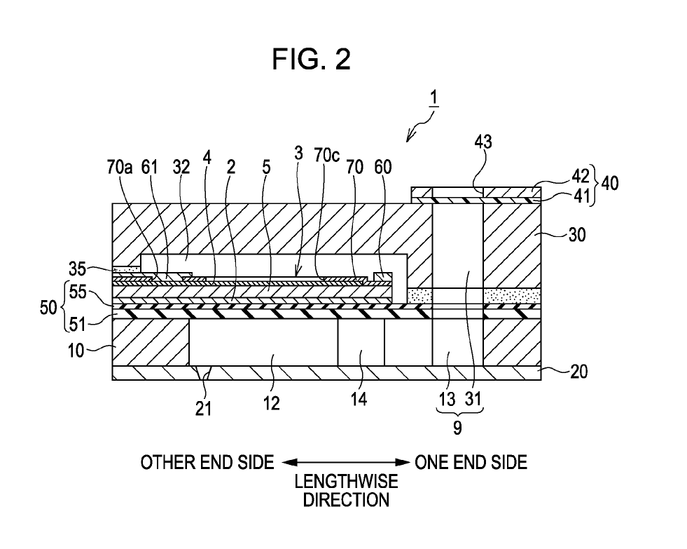

FIG. 2 is a vertical cross-sectional view taken along a surface that is parallel to the lengthwise direction of pressure generation chambers 12 in the recording head 1 and that passes through an upper electrode film 4 that corresponds to one of the pressure generation chambers 12.

The recording head 1 includes a base plate (flow channel formation plate) 10. The base plate 10 is configured of, for example, a silicon single-crystal substrate, and a vibrating plate 50 is formed on one surface thereof. The vibrating plate 50 includes, for example, an elastic film 51 configured of an oxide film that makes contact with the base plate 10 and an insulative film 55 that is configured of an oxidized film of a different material than the elastic film 51 and is layered upon the elastic film 51. A plurality of pressure generation chambers 12 that are separated by partition walls 11 and are closed on one surface by the vibrating plate 50 are arranged in the base plate 10 along the widthwise direction (the width direction) thereof.

Ink supply channels 14, which are separated by the partition walls 11 and communicate with respective pressure generation chambers 12, are provided on one side of the lengthwise direction of each of the pressure generation chambers 12 in the base plate 10. A communication portion 13 that communicates with the respective ink supply channels 14 is provided toward the outer side of the ink supply channels 14. The communication portion 13 communicates with a reservoir portion 31 in a protective substrate 30, which will be mentioned later, and thus configures part of a reservoir 9 that serves as a common ink chamber (liquid chamber) for the respective pressure generation chambers 12.

The ink supply channels 14 are formed having a cross-sectional area in the stated width direction that is narrower than the pressure generation chambers 12, and thus the flow channel resistance for the ink flowing into the pressure generation chambers 12 from the communication portion 13 is held constant. Note that the cross-sectional area of the ink supply channels 14 may be narrower than the cross-sectional area of the pressure generation chambers 12 by constricting in the thickness direction of the base plate 10, rather than constricting in the stated width direction. Furthermore, the material of the base plate 10 is not limited to a silicon single-crystal substrate, and for example, a glass ceramic, stainless steel, or the like may be used.

A nozzle plate 20 is affixed, using an adhesive, a heat-welded film, or the like, to the opposite surface of the base plate 10 as the surface on which the vibrating plate 50 is formed. Nozzle openings 21 are provided in the nozzle plate 20 in positions corresponding to the respective pressure generation chambers 12, and communicate with an area near the other end side of the stated lengthwise direction. The nozzle plate 20 is configured of, for example, a glass ceramic, a silicon single-crystal substrate, stainless steel, or the like.

A plurality of piezoelectric elements 3, having a lower electrode film 2, a piezoelectric material layer 5, and the upper electrode film 4, are formed in the stated width direction, on the surface of the vibrating plate 50 that is on the opposite side as the base plate 10. The piezoelectric elements 3 are formed in correspondence with the respective pressure generation chambers 12. The lower electrode film 2 corresponds to a first electrode formed on the side of the piezoelectric material layer 5 that faces the base plate 10. On the other hand, the upper electrode film 4 corresponds to second electrodes formed on the opposite side of the piezoelectric material layer 5 on which the first electrode is formed. The piezoelectric elements 3 include ranges in which the lower electrode film 2, the piezoelectric material layer 5, and the upper electrode film 4 overlap (functional portions). The piezoelectric elements 3 and the ranges of the vibrating plate 50 that are displaced due to driving of the piezoelectric elements 3 are referred to collectively as an actuator apparatus. Generally speaking, the piezoelectric elements 3 are configured with the electrode on one side of the piezoelectric material layer 5 serving as a common electrode and the electrodes on the other side of the piezoelectric material layer 5 serving as individual electrodes, but in this embodiment, the upper electrode film 4 serves as the individual electrodes for the respective piezoelectric elements 3 corresponding to the pressure generation chambers 12, and the lower electrode film 2 serves as the common electrode for the respective piezoelectric elements 3 that correspond to the pressure generation chambers 12.

Meanwhile, as shown in FIG. 1, a plurality of opening portions 5a (opening portions in the piezoelectric material layer), configured as recesses by removing the piezoelectric material layer 5 and the upper electrode film 4 on the piezoelectric material layer 5, are formed in the piezoelectric material layer 5. The plurality of opening portions 5a are arranged in the stated width direction, and are formed in regions that essentially correspond to the spaces between the pressure generation chambers 12. To rephrase, the piezoelectric element 3, including the functional portion, that corresponds to a single pressure generation chamber 12 is formed between an opening portion 5a and another opening portion 5a. Furthermore, as shown in FIG. 1, a plurality of opening portions 4a (opening portions in the upper electrode film 4) are formed in the piezoelectric material layer 5 by removing part of the upper electrode film 4. The plurality of opening portions 4a are also formed in the stated width direction, and the presence of the opening portions 4a ensure that spaces are provided in the upper electrode film 4 so that the individual electrodes for each of the pressure generation chambers 12 are insulated from each other.

Furthermore, the protective substrate 30, to which a compliance plate 40 is affixed, is affixed to the side of the vibrating plate 50 on which the piezoelectric elements 3 are formed. In this embodiment, the compliance plate 40 side of the recording head 1 is described as the top, whereas the nozzle plate 20 side of the recording head 1 is described as the bottom.

The protective substrate 30, which includes a piezoelectric element holding portion 32 capable of securing spaces in regions opposed to the piezoelectric elements 3 that ensure that the movement of the piezoelectric elements 3 is not interfered with, is affixed, via an adhesive 35, upon the vibrating plate 50 on which the piezoelectric elements 3 are formed. Because the piezoelectric elements 3 are formed within the piezoelectric element holding portion 32, the piezoelectric elements 3 are protected in a state in which there is almost no influence from the external environment. Furthermore, the reservoir portion 31 is provided in a region in the protective substrate 30 that corresponds to the communication portion 13 of the base plate 10. The reservoir portion 31 is provided, for example, passing through the thickness direction of the protective substrate 30 and following the width direction of the pressure generation chambers 12, and as described above, configures the reservoir 9 by communicating with the communication portion 13 of the base plate 10. Although glass, a ceramic material, metal, resin, and so on can be given as examples of the material of the protective substrate 30, it is preferable for the protective substrate 30 to be formed of a material that has approximately the same thermal expansion as the base plate 10; in this embodiment, the protective substrate 30 is formed using a silicon single-crystal substrate, which is the same material as the base plate 10.

Furthermore, FIG. 2 illustrates lead electrodes 60 and 61, a protective film 70, and so on. The lead electrodes 61 are connected to the upper electrode film 4 serving as the individual electrodes, whereas the lead electrode 60 is connected to the lower electrode film 2 serving as the common electrode. The state of connection between the lead electrodes 60 and 61 and the respective electrode films will be described later. The protective film 70 covers a predetermined range of the piezoelectric elements 3, and is configured of an insulative matter such as aluminum oxide. The range in which the protective film 70 is formed will be described later. Note that the lead electrodes 60 and 61, the protective film 70, and so on are not shown in FIG. 1. The lead electrodes 60 and 61 are connected, via lead lines or the like (not shown), to a driving circuit 120 (see FIG. 1) in which is mounted a driving IC or the like for driving the piezoelectric elements 3.

The compliance plate 40, configured of a sealing membrane 41 and an anchoring plate 42, is affixed to the top of the protective substrate 30. The sealing membrane 41 is configured of a flexible material having a low rigidity, and one surface of the reservoir portion 31 is sealed by the sealing membrane 41. The anchoring plate 42, meanwhile, is formed of a hard material such as a metal or the like. The region of the anchoring plate 42 that opposes the reservoir 9 has an opening portion 43 in which the anchoring plate 42 has been completely removed in the thickness direction, and thus one surface of the reservoir 9 is sealed using only the flexible sealing membrane 41.

With this recording head 1, ink is taken in from an external ink supply unit (not shown), and after the interior from the reservoir 9 to the nozzle openings 21 has been filled with ink, voltages are applied to the piezoelectric elements 3 corresponding to the respective pressure generation chambers 12 in accordance with recording signals from the stated driving IC, causing the piezoelectric elements 3 to bend and deform. As a result, the pressure within the pressure generation chambers 12 increases, and ink droplets (liquid) are expelled (ejected) from the nozzle openings 21.

### 2. Detailed Configuration of Piezoelectric Elements

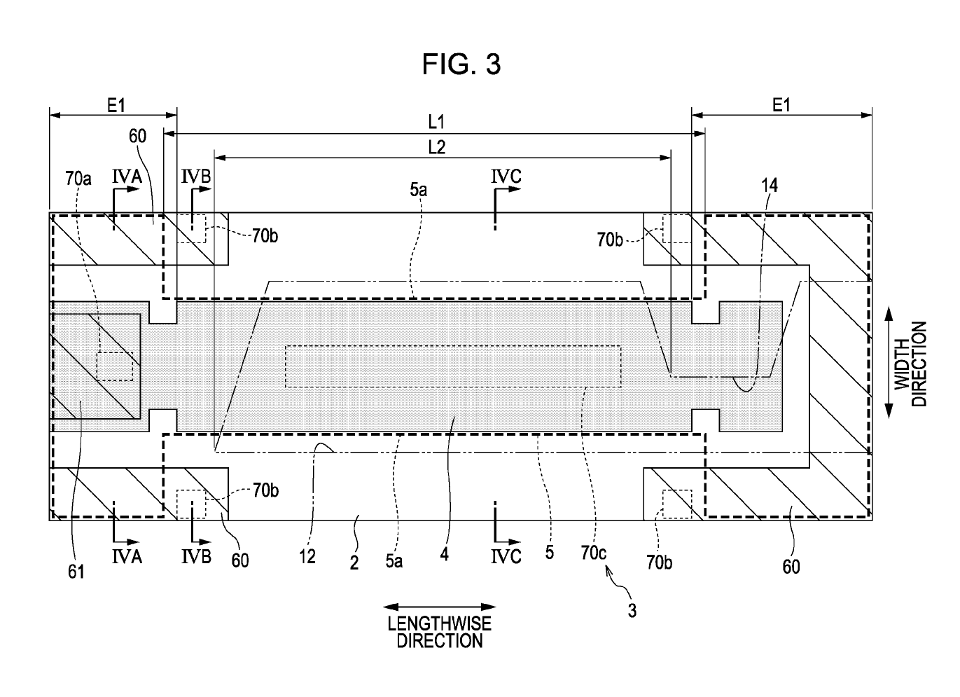

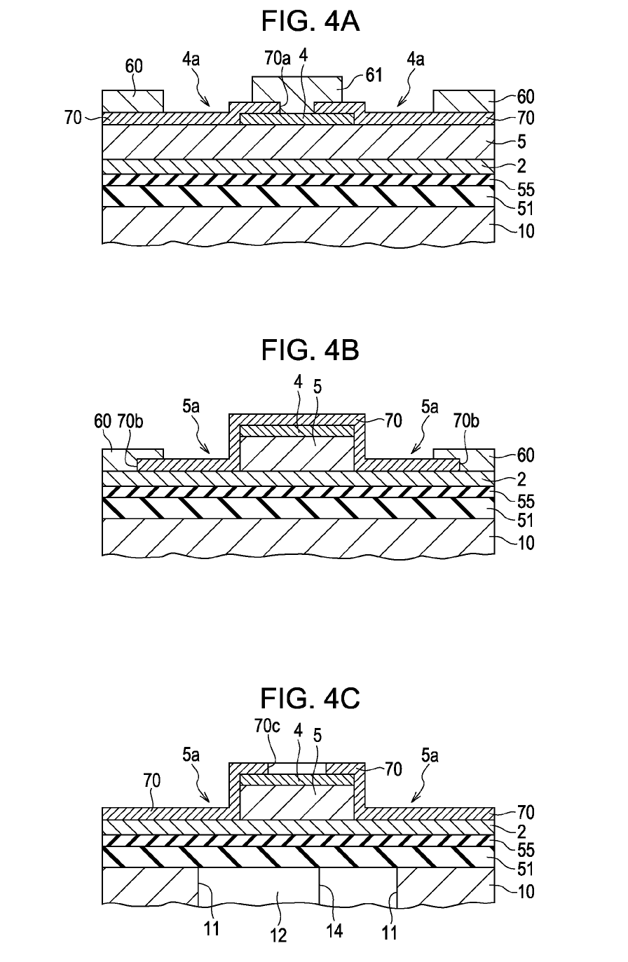

Next, the structure of the piezoelectric elements 3 according to this embodiment will be described in detail based on FIGS. 1 and 2 and FIGS. 3 through 4C. FIG. 3 is a plan view of a region upon the base plate 10, in which a piezoelectric element 3 corresponding to a single pressure generation chamber 12 is formed. FIG. 4A is a vertical cross-sectional view taken along the IVA-IVA line in FIG. 3, FIG. 4B is a vertical cross-sectional view taken along the IVB-IVB line in FIG. 3, and FIG. 4C is a vertical cross-sectional view taken along the IVC-IVC line in FIG. 3.

In FIG. 3, the shapes of the pressure generation chamber 12 and the ink supply channel 14 that communicates therewith are indicated by dot-dot-dash lines. Note that the shapes of the pressure generation chamber 12 and the ink supply channel 14 indicated in FIG. 3 are slightly different than those shown in FIGS. 1 and 2, but either shape may be employed. The lower electrode film 2 serving as the common electrode is present in all areas in the configuration shown in FIG. 3. Furthermore, in FIG. 3, an example of the range of the piezoelectric material layer 5 is indicated by a bold dotted line, and an example of the range of the upper electrode film 4 serving as the individual electrodes is indicated by a gray fill.

The stated opening portions 5a are formed in the region in the stated width direction of the pressure generation chamber 12 that essentially corresponds to both sides of the partition walls 11, and the piezoelectric material layer 5 is removed in the areas corresponding to the opening portions 5a, as can be seen in FIGS. 4B and 4C. The opening portions 5a are formed so that a length L1 in the stated lengthwise direction is greater than a length L2 of the pressure generation chamber 12 in the stated lengthwise direction (L1>L2). In addition, both ends of the piezoelectric material layer 5 in the stated lengthwise direction are formed so as to extend to the outer sides of the pressure generation chamber 12, and the length of the pressure generation chamber 12 is completely covered thereby. The presence of such opening portions 5a ensures that the width of the piezoelectric material layer 5 on the pressure generation chamber 12 falls within the width of the pressure generation chamber 12. The upper electrode film 4 is formed at the same width as the piezoelectric material layer 5 upon the pressure generation chamber 12, and is formed so that both ends thereof in the stated lengthwise direction extend to the outer sides of the pressure generation chamber 12, thus completely covering the length of the pressure generation chamber 12.

FIGS. 3 through 4C illustrate protective film through-holes 70a, 70b, and 70c (the protective film through-holes 70a and 70c are also illustrated in FIG. 2). The protective film through-holes 70a, 70b, and 70c are holes that pass through the protective film 70. To rephrase, the range of the lower electrode film 2 not covered by both the piezoelectric material layer 5 and the upper electrode film 4, the range of the piezoelectric material layer 5 not covered by the upper electrode film 4, and the range of the upper electrode film 4 are completely covered by the protective film 70 aside from the locations where the protective film through-holes 70a, 70b, and 70c are provided. Note that in FIG. 3, the protective film 70 has been omitted. The protective film through-hole 70a is formed in a region of the upper electrode film 4 that does not overlap with the pressure generation chamber 12 and that is on the other end side in the stated lengthwise direction, and partially exposes the upper electrode film 4. In addition, the lead electrodes 61 are formed around the protective film through-hole 70a, and the lead electrodes 61 make contact with the upper electrode film 4 via the protective film through-hole 70a. Note that in FIG. 3, an example of the range in which the lead electrodes 60 and 61 are formed is indicated by hatching.

The protective film through-holes 70b are formed in positions of the lower electrode film 2 that is within a range corresponding to the opening portions 5a and that are near both ends of the opening portions 5a in the stated lengthwise direction (in four positions, in FIG. 3), and partially expose the lower electrode film 2. In addition, the lead electrode 60 is formed around the protective film through-holes 70b, and the lead electrode 60 makes contact with the lower electrode film 2 via the protective film through-holes 70b. The protective film through-hole 70c is formed, in approximately the center of a region of the upper electrode film 4 that overlaps the pressure generation chamber 12, as a long-hole that follows the lengthwise direction, and exposes part of the upper electrode film 4. Forming the protective film through-hole 70c makes it possible to prevent the protective film 70 from interfering with the displacement of the piezoelectric element 3 and maintain or improve the amount by which the piezoelectric element 3 displaces.

Note that the configuration illustrated in FIG. 3 is formed on the base plate 10 (and more precisely, on the insulative film 55) in a pattern that repeats in the stated width direction in correspondence with the pressure generation chambers 12, and thus the lower electrode film 2, the piezoelectric material layer 5 and lead electrode 60, and the protective film 70 are each formed in a continuous manner in the stated width direction (see FIG. 1 as appropriate). In addition, the lead electrodes 60 illustrated in FIG. 3 as being formed in a plurality of locations are connected to each other at predetermined locations (not shown), and thus form a single common electrode when taken together.

As can be seen from the respective drawings, one feature of this embodiment is that the base layer of the piezoelectric material layer 5 is always the lower electrode film 2. In other words, the piezoelectric material layer 5 is not formed in direct contact with a layer aside from the lower electrode film 2 (for example, the insulative film 55) serving as its base layer. By forming the entire base layer of the piezoelectric material layer 5 as the lower electrode film 2, cracking in the piezoelectric material layer 5 that can occur when the piezoelectric material layer 5 is formed upon the insulative film 55 (ZrO₂) can be avoided, which makes it possible to manufacture the piezoelectric element 3 with no (or fewer) problems. In the particular case where a non-leaded perovskite oxidant is used as the material of the piezoelectric material layer 5, it has been highly likely that the aforementioned cracks will occur, and thus this embodiment is particularly useful when forming the piezoelectric material layer 5 using such a non-leaded material.

Meanwhile, the base layer of the piezoelectric material layer 5 always being the lower electrode film 2 means that past processes for patterning the lower electrode film 2 prior to forming the piezoelectric material layer 5, and in particular a special process for suppressing the abnormal growth of crystals when forming a piezoelectric material layer upon the insulative film 55 using a lead zirconate titanate material, need not be carried out. Therefore, according to this embodiment, the piezoelectric elements 3 can be manufactured more efficiently, with fewer steps than in the past.

Not patterning the lower electrode film 2 prior to forming the piezoelectric material layer 5 as described above also means that a layer of the lower electrode film 2 remains in the region where the piezoelectric material layer 5 is formed and in many other regions. If the lower electrode film 2 remains in many regions in this manner, there is a higher risk that shorts will occur between the lower electrode film 2 and the upper electrode film 4. Accordingly, in this embodiment, various types of measures are taken so that such shorts will not occur. Specifically, the upper electrode film 4 that serves as the individual electrodes is formed so that the individual electrodes are separated from each other in regions upon the piezoelectric material layer 5 that is formed continuously. As described above, the upper electrode film 4 is connected to the lead electrodes 61 at each instance of the upper electrode film 4 at the other end side in the stated lengthwise direction; here, the piezoelectric material layer 5 is not removed and is instead formed continuously in the stated width direction in the vicinity of the areas that are connected to the lead electrodes 61, and thus the respective instances of the upper electrode film 4 are separated from each other upon the piezoelectric material layer 5.

In FIG. 3, an etching region that is to be processed when etching the upper electrode film 4 in order to separate individual instances of the upper electrode film 4 is indicated as a range E1. Of the region included in the range E1 in the stated lengthwise direction, the region in which the upper electrode film 4 does not remain in FIG. 3 corresponds to the stated etching region. Aside from overlapping regions, which will be mentioned later, this etching region corresponds to the aforementioned opening portions 4a (see FIG. 1 and FIG. 4A). Assuming, for example, that the regions of the aforementioned opening portions 4a are recesses in which the piezoelectric material layer 5 is not present (called “inter-wiring recesses”), the risk of shorts between the upper electrode film 4 and the lower electrode film 2 is increased through the inter-wiring recesses. This is because the lead electrodes 61 are formed upon the upper electrode film 4, but the respective instances of the upper electrode film 4 are formed in correspondence with the respective pressure generation chambers 12, which in turn are formed at extremely small intervals in the stated width direction, such as 720 dpi or the like. Accordingly, even a small amount of skew in the positions in which the lead electrodes 61 are formed relative to the upper electrode film 4 will cause the lead electrodes 61 to partially fall into the inter-wiring recesses, bringing the lead electrodes 61 into extremely close proximity to the lower electrode film 2.

Even if the lead electrodes 61 have partially approached the lower electrode film 2 via the inter-wiring recesses, the presence of the protective film 70 and so on does make it possible to avoid a state in which the two come into contact. However, the protective film 70 is required to be formed at a high thickness if the stated shorts are to be prevented with certainty using only the protective film 70; at the same time, increasing the thickness of the protective film 70 is also considered problematic in that doing so can reduce the amount by which the piezoelectric elements 3 displace. Meanwhile, in this embodiment, the piezoelectric material layer 5 remains in the locations of the inter-wiring recesses, and the respective instances of the upper electrode film 4 are separated by the continuous piezoelectric material layer 5; the piezoelectric material layer 5 acts as an insulating film between the upper electrode film 4 and the lower electrode film 2, and thus there is an extremely low risk of the stated shorts. In addition, in this embodiment, the lead electrodes 61 that connect to the respective separated instances of the upper electrode film 4 are also formed within the range in which the piezoelectric material layer 5 is formed, and thus it is possible to avoid, with certainty, a state in which the lead electrodes 61 short with the lower electrode film 2 that is located therebelow with the piezoelectric material layer 5 positioned therebetween.

Here, it can be seen in FIG. 3 that the stated etching region overlaps with part of the regions of the opening portions 5a (the ends of the opening portions 5a in the stated lengthwise direction; in FIG. 3, the regions within the opening portions 5a in which L1 and E1 overlap). These partial regions correspond to the aforementioned overlapping regions. These overlaps are purposefully produced in order to ensure the state of insulation between the instances of the upper electrode film 4 in the stated width direction. Unnecessary portions of the upper electrode film 4 are removed from upon the piezoelectric material layer 5 through photoetching in order to separate the instances of the upper electrode film 4 from each other as described above. At this time, assuming the processing is to be carried out up to a border between the region where the piezoelectric material layer 5 and the upper electrode film 4 are layered and the opening portions 5a (the region in which the piezoelectric material layer 5 and the upper electrode film 4 have been removed), there is a risk, in the case where the positional adjustment of a mask for carrying out a pre-etching exposure process is insufficient, that the upper electrode film 4 that is to be removed from upon the piezoelectric material layer 5 will remain in the vicinity of the stated border. The upper electrode film 4 that remains in this manner may be connected to the upper electrode film 4 formed in correspondence with the adjacent pressure generation chambers 12 in the stated width direction, and thus shorts may occur between the upper electrode films 4 formed in correspondence with the pressure generation chambers 12. Accordingly, in this embodiment, the stated etching region is, as described above, set to be wide so as to partially include the opening portions 5a, and thus the upper electrode film 4 that is to be removed at the stated border is removed with certainty. Accordingly, shorts between the instances of the upper electrode film 4 formed in correspondence with the pressure generation chambers 12 are prevented with certainty.

Furthermore, in this embodiment, measures are taken to make the stated overlapping regions thinner. The opening portions 5a are originally regions formed by etching the upper electrode film 4 and the piezoelectric material layer 5 in those ranges. Accordingly, the stated overlapping regions are targets for etching carried out in order to form the opening portions 5a and etching carried out in order to form the opening portions 4a, and is thus possible that the thickness thereof (that is, the thickness including the lower electrode film 2 and the vibrating plate 50) will be reduced more than necessary. The rigidity of the overlapping regions is reduced by reducing the thickness in this manner. In the case where the locations where the rigidity has decreased are vibrated, bent, or the like, there is a risk that damage such as cracks will occur on the base plate 10. Accordingly, in this embodiment, the end portions of the opening portions 5a are positioned on the outer side of the range of the pressure generation chambers 12 (L2, in FIG. 3) in the stated lengthwise direction, and the stated overlapping regions are positioned on that outer side. In other words, disposing the stated overlapping regions on the outside of the range of the pressure generation chambers 12, which correspond to the functional portions of the piezoelectric elements 3 that bend and deform, reduces the influence of vibrations, bending, or the like on the overlapping regions caused by the stated deformation and prevents the stated overlapping regions from being damaged.

### 3. Manufacturing Method

Next, an example of a method for manufacturing the recording head 1 according to this embodiment will be described.

First, the elastic film 51 configured of silicon dioxide (SiO₂) and the insulative film 55 configured of zirconium oxide (ZrO₂) are formed on the entire surface of the base plate 10 that is a silicon single-crystal substrate (see JP-A-2005-8841).

Next, the lower electrode film 2 is formed by layering platinum and iridium on the entire surface of the insulative film 55 through, for example, sputtering.

Next, the piezoelectric material layer 5 is formed on the entire surface of the lower electrode film 2 using, for example, the sol-gel method. In other words, it can be seen that the processes carried out thus far result in the lower electrode film 2 serving as the base layer for the entire piezoelectric material layer 5.

Next, the upper electrode film 4, configured of, for example, iridium, is formed on the entire surface of the piezoelectric material layer 5 through, for example, sputtering.

Next, the opening portions 5a are formed by etching predetermined ranges of the upper electrode film 4 and the piezoelectric material layer 5. As a result, the lower electrode film 2 is exposed in the opening portions 5a.

Next, the opening portions 4a are formed by etching the upper electrode film 4 upon the piezoelectric material layer 5. At this time, the overlapping regions are etched for a second time. As a result, the piezoelectric material layer 5 is exposed in the opening portions 4a.

Next, the protective film 70 is generated on the entire surface formed through the process thus far, and the protective film through-holes 70a, 70b, and 70c are formed by etching the protective film 70 in a predetermined pattern.

Next, the lower electrode film 2 is removed from unnecessary locations on the base plate 10 (patterning of the lower electrode film 2 through etching). Note that the piezoelectric material layer 5, the upper electrode film 4, and so on are also removed from the lower electrode film 2 in areas where that layer/film is present. “Unnecessary locations” mentioned here refers to locations unrelated to wiring channels for driving the piezoelectric elements 3, locations that are unnecessary as the actuator apparatus, and so on, and correspond to, for example, locations between chips. Note that a plurality of recording heads 1 are formed from a single wafer (the silicon single-crystal substrate that serves as the base plate 10), and are ultimately cut out as chips from the wafer. In the process for removing the unnecessary locations, the unnecessary locations are also etched from the vibrating plate 50, and as a result, for example, locations for enabling the communication portion 13 and the reservoir portion 31 to communicate are removed.

Next, a metal layer including, for example, gold (Au) and nichrome (NiCr) is formed on the entire surface formed thus far through sputtering or the like, and the lead electrodes 60 and 61 are then formed by etching the metal layer in a predetermined pattern. After this, once the protective substrate 30 has been affixed to the side on which the piezoelectric elements 3 are present, the pressure generation chambers 12, ink supply channels 14, and so on have been formed by etching the base plate 10, the nozzle plate 20 has been affixed to the base plate 10, and the compliance plate 40 has been affixed to the protective substrate 30, the chips are finally cut out from the wafer, thus completing a plurality of recording heads 1. Note that the aforementioned method for manufacturing the recording head 1 is merely an example, and various changes are possible as long as the process for generating the piezoelectric material layer 5 with the lower electrode film 2 serving as the base layer is carried out before the lower electrode film 2 is patterned. The aforementioned method for forming the piezoelectric material layer is also not limited, and the piezoelectric material layer may be formed through sputtering. In addition, as described above, various types of materials can be employed as the material of the piezoelectric material layer, such as a lead zirconate titanate material, a non-leaded (that is, not containing lead elements) perovskite oxidant such as barium titanate, and so on.

### 4. Variations

The invention is not intended to be limited to the aforementioned embodiment, and the invention can be realized in various forms without departing from the essential spirit thereof; for example, variations such as those described hereinafter are also possible. Appropriate combinations of the embodiment and the variations also fall within the scope of the disclosure of the invention.

The following will describe points that differ from the aforementioned embodiment, and descriptions of configurations, effects, and so on that are the same as in the aforementioned embodiment will be omitted as appropriate.

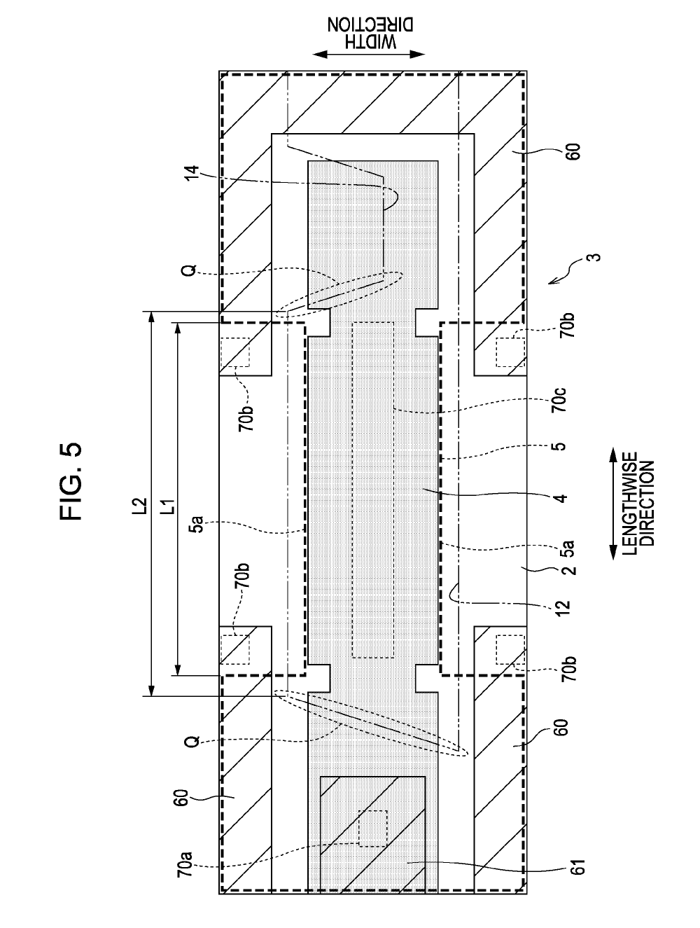

FIG. 5 is a plan view illustrating a partial region of the base plate 10 according to a variation, and like FIG. 3, illustrates a region in which a piezoelectric element 3 that corresponds to a single pressure generation chamber 12 is formed. Comparing the configurations illustrated in FIG. 5 and FIG. 3, the length L1 of the opening portions 5a in the stated lengthwise direction differs between the two. Specifically, the length L1 of the opening portions 5a shown in FIG. 5 is shorter, and the opening portions 5a are formed within the range of the pressure generation chamber 12 in the stated lengthwise direction (that is, the range indicated by L2 in FIG. 5). Stress from the piezoelectric element 3 that bends and deforms concentrates particularly near both ends of the pressure generation chamber 12 in the stated lengthwise direction (locations surrounded by ellipses Q in FIG. 5), and it is thus possible that problems such as cracks will arise in the piezoelectric material layer 5 due to the stated stress concentration. Accordingly, in this variation, the opening portions 5a in the piezoelectric material layer 5 are, as illustrated in FIG. 5, formed on the inner side of the range of the pressure generation chamber 12, which leaves a larger amount of the piezoelectric material layer 5 in the vicinity of the ends of the pressure generation chamber 12; this improves the rigidity of the piezoelectric element 3 near those ends. This makes it possible to avoid the occurrence of problems such as cracking caused by the aforementioned concentration of stress.

### Other

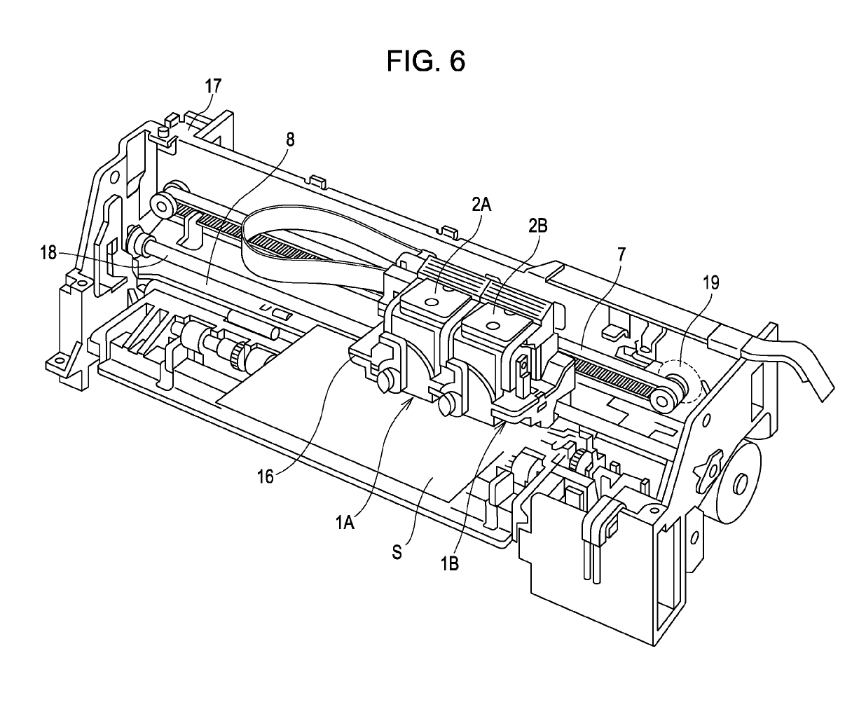

The recording head 1 described above configures part of a recording head unit including an ink flow channel that communicates with an ink cartridge or the like, which is in turn installed in an ink jet recording apparatus serving as a liquid ejecting apparatus. FIG. 6 is a schematic diagram illustrating an example of such an ink jet recording apparatus. As shown in FIG. 6, recording head units 1A and 1B that have recording heads are provided with cartridges 2A and 2B that configure ink supply units and are removable; a carriage 16, in which these recording head units 1A and 1B are installed, is provided so as to move freely in the axial direction of a carriage shaft 18 attached to an apparatus main body 17. These recording head units 1A and 1B each eject, for example, black ink compounds and color ink compounds. Transmitting driving force generated by a driving motor 19 to the carriage 16 via a plurality of gears (not shown) and a timing belt 7 moves the carriage 16, in which the recording head units 1A and 1B are installed, along the carriage shaft 18. Meanwhile, a platen 8 is provided in the apparatus main body 17 along the same direction as the carriage shaft 18, and a recording sheet S, which is a recording medium such as paper supplied by paper supply rollers and the like (not shown), is transported upon the platen 8.

Although the above describes an ink jet recording head as an example of a liquid ejecting head according to the invention, the liquid ejecting head is not limited to the configuration described above. The invention applies generally to all types of liquid ejecting heads, and can of course be applied in heads that eject liquids aside from ink. Various types of recording heads used in image recording apparatuses such as printers, coloring material ejecting heads used in the manufacture of color filters for liquid-crystal displays and the like, electrode material ejecting heads used in the formation of electrodes for organic EL displays, FEDs (field emission displays), and so on, bioorganic matter ejecting heads used in the manufacture of biochips, and so on can be given as other examples of liquid ejecting heads.

What is claimed is:

1. A liquid ejecting head comprising:
a substrate in which pressure generation chambers that communicate with corresponding nozzle openings are formed; and
piezoelectric elements including a piezoelectric material layer, a first electrode formed on the side of the substrate that faces the piezoelectric material layer, and second electrodes formed on the opposite side of the piezoelectric material layer as the side on which the first electrode is formed,
wherein the piezoelectric material layer is formed upon the entirety of the first electrode.

2. The liquid ejecting head according to claim 1,
wherein the second electrodes are formed in correspondence with respective pressure generation chambers, and the second electrodes are formed separated from each other by regions on the piezoelectric material layer formed in a continuous manner.

3. The liquid ejecting head according to claim 2, further comprising:
lead electrodes connected to respective second electrodes,
wherein the lead electrodes are formed within a region in which the piezoelectric material layer is formed.

4. The liquid ejecting head according to claim 2, further comprising:
opening portions in the piezoelectric material layer formed by removing the second electrodes and the piezoelectric material layer in regions essentially corresponding to spaces between the pressure generation chambers, and opening portions in the second electrodes formed by partially removing the second electrodes on the continuous piezoelectric material layer in order to separate the second electrodes,
wherein ends of the opening portions in the piezoelectric material layer are also etched when forming the opening portions in the second electrodes.

5. The liquid ejecting head according to claim 4,
wherein the ends of the opening portions in the piezoelectric material layer are positioned on the outer side of the range of the pressure generation chambers in the lengthwise direction of the pressure generation chambers.

6. The liquid ejecting head according to claim 1, further comprising:
an opening portion in the piezoelectric material layer formed by removing the second electrodes and the piezoelectric material layer in regions essentially corresponding to spaces between the pressure generation chambers,
wherein the opening portions in the piezoelectric material layer are formed within the range of the pressure generation chambers in the lengthwise direction of the pressure generation chambers.

7. A liquid ejecting apparatus comprising:
the liquid ejecting head according to claim 1.

8. A liquid ejecting apparatus comprising:
the liquid ejecting head according to claim 2.

9. A liquid ejecting apparatus comprising:
the liquid ejecting head according to claim 3.

10. A liquid ejecting apparatus comprising:
the liquid ejecting head according to claim 4.

11. A liquid ejecting apparatus comprising:
the liquid ejecting head according to claim 5.

12. A liquid ejecting apparatus comprising:
the liquid ejecting head according to claim 6.
